(19) United States
(12) Patent Application Publication
(10) Pub. No.: US 2023/0221441 A1
(43) Pub. Date: Jul. 13, 2023

(54) LIGHT-BASED SPATIAL ESTIMATION TRANSMISSION AND RECEPTION SYSTEMS

(71) Applicant: BARAJA PTY LTD, North Ryde, New South Wales (AU)

(72) Inventor: Harry Dudley-Bestow, North Ryde, New South Wales (AU)

(21) Appl. No.: 18/008,788

(22) PCT Filed: Jun. 11, 2021
(86) PCT No.: PCT/AU2021/050601

§ 371 Date: Dec. 7, 2022

(30) Foreign Application Priority Data
Jun. 12, 2020 (AU) 2020901939
Apr. 12, 2021 (AU) 2021901057

(51) Int. Cl. G01S 17/89; G01S 7/481; G01S 7/484; G01S 7/487

(52) U.S. Cl. CPC G01S 17/89; G01S 7/484; G01S 7/487; G01S 7/4814

(57) ABSTRACT

Methods for use in a spatial profiling system for detecting targets in an environment are described. The methods include detecting first incoming reflected light from an environment and second incoming light from the environment, the second incoming light including reflected noise light from the spatial profiling system. The spatial profile estimation is based on the detected first incoming light and the detected second incoming light. Embodiments of a spatial profiling system configured to operate in accordance with the methods are also described.

### FIELD OF THE DISCLOSURE

The present disclosure generally relates to the field of spatial profile estimation of an environment, including using light to remote sense the environment.

### BACKGROUND

Spatial profiling refers to the mapping of an environment as viewed from a desired origin point. Each point or pixel in the field of view is associated with a distance to form a representation of the environment. Spatial profiles may be useful in identifying targets in the environment, including objects and/or obstacles in the environment, thereby facilitating automation of tasks.

One technique of spatial profiling involves sending light into an environment in a specific direction and detecting any light reflected back from that direction, for example, by a reflecting surface in the environment. The reflected light carries relevant information for determining the distance to the reflecting surface. For example, if the light is pulsed, the time of flight of a return pulse indicates distance to the reflecting surface. The combination of the specific direction and the distance forms a point or pixel in the representation of the environment. The above steps may be repeated, sequentially or simultaneously, for multiple different directions to form other points or pixels of the representation, thereby facilitating estimation of the spatial profile of the environment within a desired field of view. These techniques may be variously referred to as LiDAR (light detection and ranging), LADAR (laser detection and ranging), as well as other references.

The presence of interference signals in a LiDAR system can adversely affect operation of the LiDAR system. Therefore in many applications there is a need to address interference.

### SUMMARY OF THE DISCLOSURE

Methods and systems configured to assist with the identification of interference signals in a LiDAR system are described. The interference signals may be reflections, such as retroreflections, from outside of a current operating field of view of the LiDAR system, due to transmission by the LiDAR system of wavelengths and/or along directions other than the wavelengths and/or directions designated for target finding. Detection of reflected light by the LiDAR system is performed upon return of signals transmitted with distinguishable optical characteristics for generating data for spatial profiling.

In some embodiments a method for use in a spatial profiling system for detecting targets in an environment includes:
by optical and electrical components of a spatial profiling system:
   sending first outgoing light into the environment, the first outgoing light including a signal with first characteristics for detection of diffuse targets in the environment;
   sending second outgoing light into the environment, the second outgoing light including a signal with second characteristics different to the first characteristics and an intensity or spectral power density less than the first outgoing light;
   detecting incoming light including first incoming light and second incoming light, wherein the first incoming light is a portion of the first outgoing light reflected by a target in the environment and the second incoming light is a portion of the second outgoing light reflected by a target in the environment;
generating, by the spatial profiling system, data including information identifying detection of the first incoming light and information identifying detection of the second incoming light; and
causing an action by the spatial profiling system based on the information identifying detection of the second incoming light.

The method may further include determining, by the spatial profiling system based on the detected first incoming light and second incoming light, presence of both a diffuse target and a retroreflector target in the environment. Location information may also be determined for one or both of the diffuse target and retroreflector.

In some embodiments, a method for use in a spatial profiling system for detecting targets in an environment includes:
by optical and electrical components of a spatial profiling system:
   in a first period of time, sending first outgoing light into the environment, the first outgoing light including signal and noise;
   in a second period time different to the first period of time, sending second outgoing light into the environment, the second outgoing light including noise and no or substantially reduced signal;
   detecting first incoming light including a portion of the first outgoing light reflected by a said target in the environment;
   detecting second incoming light including a portion of the second outgoing light reflected by a said target in the environment;
generating, by the spatial profiling system, data including information identifying detection of the portion of the first outgoing light reflected by a said target in the environment and information identifying detection of the portion of the second outgoing light reflected by a said target in the environment; and
causing an action by the spatial profiling system based on the information identifying detection of the portion of the second outgoing light reflected by a said target in the environment.

In some embodiments the method further includes:
determining that there is a match between:
   a time separation between a detected return signal in the first detected incoming light and a detected return signal in the second detected incoming light; and
   a time separation of the first period to time and the second period of time;
wherein the causing of the action by the spatial profiling system is responsive to the determination of a match.

In some embodiments the signal includes light from a laser light source with wavelengths within a wavelength range and the noise includes light outside of the wavelength range. The method may include controlling the laser light source so that the second outgoing light includes no signal. The laser light source may include a laser and the method may include controlling a gain of the laser to zero for sending the second outgoing light into the environment.

The method may include setting a gain of the laser to an operational value for the first time period before commencement of the first time period and controlling an amplifier for the laser light source to an operational state from a non-operational state to commence the first time period. The second time period may follow the first time period and the method may include transitioning from a configuration for the first time period to a configuration for the second time period by setting the gain of the laser to a non-operational value to end the first time period while maintaining the amplifier in the operational state. Transitioning from a configuration for the second time period may include transitioning the amplifier from the operational state to the non-operational state.

In some embodiments the optical and electrical components include a laser light source with an associated amplifier, controlled by one or more processing units and the method includes:
configuring, by the one or more processing units, the laser light source and the amplifier into a first configuration in which both are operated to generate the signal;
configuring, by the one or more processing units, the laser light source and the amplifier into a second configuration in which the laser light source ceases generating signal and the amplifier remains in the same operating state as the first configuration; and
applying, by the one or more processing units, the first configuration during one of the first time period and the second period and the second configuration during the other time period of the first time period and the second time period.

The method may then include:
modulating the first outgoing light and the second outgoing light, wherein the modulation of the second outgoing light is reverse or opposite to the modulation of the first outgoing light; and
detecting the return signal in the first detected incoming light and detecting the return signal in the second detected incoming light based on the modulation of the first outgoing light.

In some embodiments, a method for use in a spatial profiling system for detecting targets in an environment includes:
by a light receiver of a spatial profiling system:
   detecting first incoming light from an environment, the first incoming light including reflected laser light from the spatial profiling system;
   detecting second incoming light from the environment, the second incoming light including reflected noise light from the spatial profiling system while the laser light is not transmitted;
by a processing system of the spatial profiling system:
   modifying data for a spatial profile estimation based on the detected first incoming light, wherein the modifying is based on the detected second incoming light.

In some embodiments the method further includes:
determining that a time separation between a first detected return signal in the first detected incoming light and a second detected return signal in the second detected incoming light is within a threshold range;
wherein the modification of the data for the spatial profile estimation is responsive to the determination.

In some embodiments the laser light and the noise light are modulated by a modulator according to a modulation structure and the method includes detecting the first detected return signal and the second detected return signal by a process comprising correlating the first incoming light and the second incoming light with the modulation structure. The modification of the data for the spatial profile estimation may also be responsive to a determination based on the relative magnitudes of correlation for the first detected return signal and the second detected return signal.

Embodiments of a spatial profiling system include:
optical components for directing outgoing light into an environment and receiving light from the environment including outgoing light reflected by the environment, the outgoing light including laser light for spatial profiling, the optical components directing light based its wavelength;
one or more noise generating components that operate to add noise to the directed outgoing light;
a light receiver and processing unit configured generate data for a spatial estimation of the environment based on the light received from the environment;
wherein the light receiver and processing unit is configured to:
   detect first incoming light from an environment, the first incoming light including reflected laser light from the spatial profiling system;
   detect second incoming light from the environment, the second incoming light including reflected noise light from the spatial profiling system while the laser light is not transmitted;
   modify data for a spatial profile estimation of the environment based on the detected first incoming light, wherein the modifying is based on the detected second incoming light.

The one or more noise generating components may include an optical or a non-optical amplifier.

The spatial profiling system may include a modulator configured to modulate the outgoing light and the noise, wherein the light receiver and processing unit is configured to detect the reflected laser light and reflected noise light based on the modulation imparted to the outgoing light by the modulator.

Embodiments of a non-transient computer readable medium store instructions configured to cause a processing system of a spatial profiling system to perform the method described herein.

### BRIEF DESCRIPTION OF THE DRAWINGS

FIG. 1 generally illustrates, in block diagram form, an arrangement of a spatial profiling system.

FIG. 2 shows block diagram representation of example embodiments of a spatial profiling system.

FIG. 3 shows a diagrammatic representation of an optical amplifier.

FIG. 4A illustrates an arrangement of a light source, optical amplifier and processing unit for use in a spatial profiling system.

FIGS. 4B and 4C illustrates example signals of the arrangement of FIG. 4A.

FIGS. 5A to 5D show example signals of a light receiver and associating processing system in a spatial profiling system.

FIG. 5E shows example signals of another light receiver and associating processing system in a spatial profiling system.

FIG. 6 shows a flow diagram representation of a method for a spatial profiling system.

FIG. 7 illustrates a method of reducing occurrence of false negatives according to an embodiment of the present disclosure.

FIGS. 8A, 8B illustrate a comparison between a perfect optical system and an imperfect optical system in the presence of a retroreflector.

### DETAILED DESCRIPTION OF EMBODIMENTS

Disclosed herein is a system and method for facilitating estimation of a spatial profile of an environment based on a light detection and ranging (LiDAR) based technique. “Light” hereinafter includes electromagnetic radiation having optical frequencies, including far-infrared radiation, infrared radiation, visible radiation and ultraviolet radiation. In this specification, “intensity” means optical intensity and, unless otherwise stated, is interchangeable with “optical power”.

In general, LiDAR involves sending light into the environment and subsequently detecting reflected light returned by the environment. The distance of surfaces within a field of view can be determined based on the returned light, for example by determining the time it takes for the light to make a round trip, and an estimation of the spatial profile of the environment may be formed.

Some LiDAR systems utilise a bank of lasers, at different oriented angles. Each laser may send out a beam of light as a laser channel that is returned to the system for detection. Interference between the individual laser channels is possible. For example a retroreflector may return light at 60 dB or more than diffuse targets in an environment, so that reflections from a retroreflector are of sufficient intensity and size to be received at multiple receivers at once, causing spurious false returns.

Some LiDAR systems utilise a single laser. For example a flash lidar system may utilise a laser to illuminate a field of view and a camera receiver with a grid of pixels. The time of flight at the various pixels is determinable to obtain an estimation of the spatial profile within the field of view. A retroreflector may also cause interference in a flash LiDAR system, potentially across all pixels in the receiver.

Some LiDAR systems use a beam director to direct one or more beams of laser light in specific directions within a field of view. The beam director may for example, include mechanical directors, for instance one or more rotatable mirrors. The beam director may include optical directors, for example directing a beam based on its wavelength, which may vary over time. A retroreflector may also cause interference in beam directed systems.

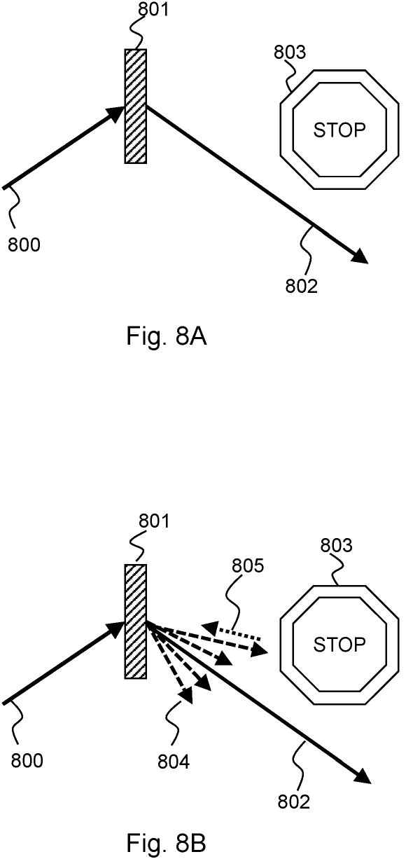

Retroreflectors in an environment provide a substantially higher return signal in comparison to diffuse targets. For at least some types of light receiver, for example light receivers that include avalanche photodiodes in the light detector, the substantially higher return signal can lead to saturation of the detector. The saturation may result in a less accurate distance estimation for the retroreflector. Further, imperfections in optical systems may be magnified by the presence of a nearby retroreflector, and manifest as false return signals, for example associated with transmission directions surrounding the retroflector, as depicted in FIGS. 8A, 8B. FIG. 8A shows a perfect optical system in which light originating from a light source 800 passes through transmission optics 801 and provides a strong light signal 802 at an intended transmission direction near a retroreflector 803. FIG. 8B shows an imperfect optical system in the light from a light source 800 passes through transmission optics 801 and additionally provides weak light signals 804, one or more of which are reflected by the retroreflector 803 to provide a false return 805 associated with the intended transmission direction.

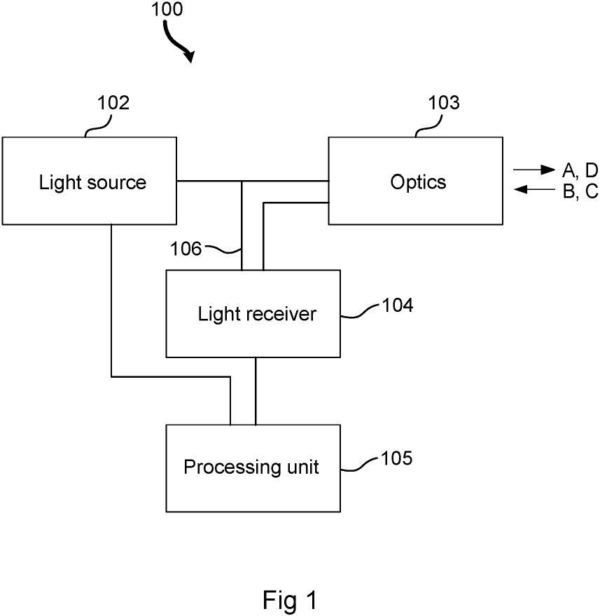

FIG. 1 generally illustrates, in block diagram form, an arrangement of a spatial profiling system 100. The system 100 includes a light source 102, optical components 103, a light receiver 104 and a processing unit 105. Each of the light source 102, optical components 103, and light receiver 104 will have one of several different forms, depending on the method of LiDAR being utilised.

For example, the light source 102 may be a single light source in the case of a flash LiDAR system, a bank of lasers when the LiDAR individually directs light from each laser or one or more variable wavelength light sources when the LiDAR directs light based on wavelength. The optical components 103 are configured to receive light from the light source and provide it to the environment. One or more amplifiers (not shown in FIG. 1) may be provided between the light source 102 and the optical components 103 to boost the optical power of the outgoing light. The optical components 103 may have separate transmission and reception modules, with distinct components. Alternatively the optical components 103 for transmission and reception may overlap, for instance through use of an optical circulator. The light receiver 104 may include a single detector or a plurality of detectors for providing a suitable signal to the processing unit 105 for range determination. The processing unit 105 is operatively coupled to the light receiver 104 for controlling its operations, to generate a measure of the received signal indicative of the output power received by the light detector(s) of the light receiver 104, and generating data for spatial estimation, including in particular data for determining the distance to the reflecting surface. The data may be based on a measure of the round-trip time for the reflected light. The processing unit 105 is also operatively coupled to the light source 102 for controlling its operations. The processing unit 105 may additional determine the distance to each reflecting surface and/or generate data indicating a spatial profile estimation. Alternatively one or both of these functions may be performed by another processing unit that receives data from the processing unit 105.

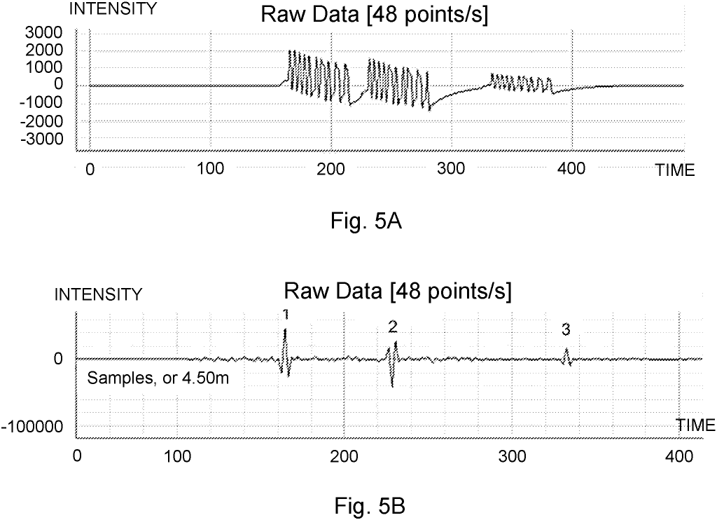

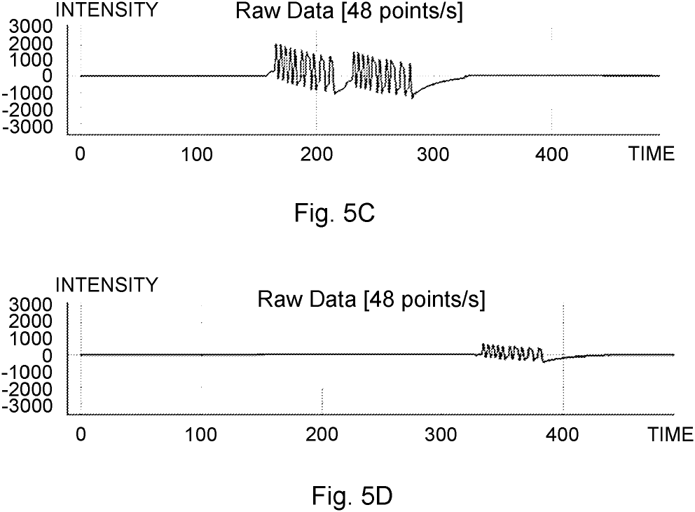

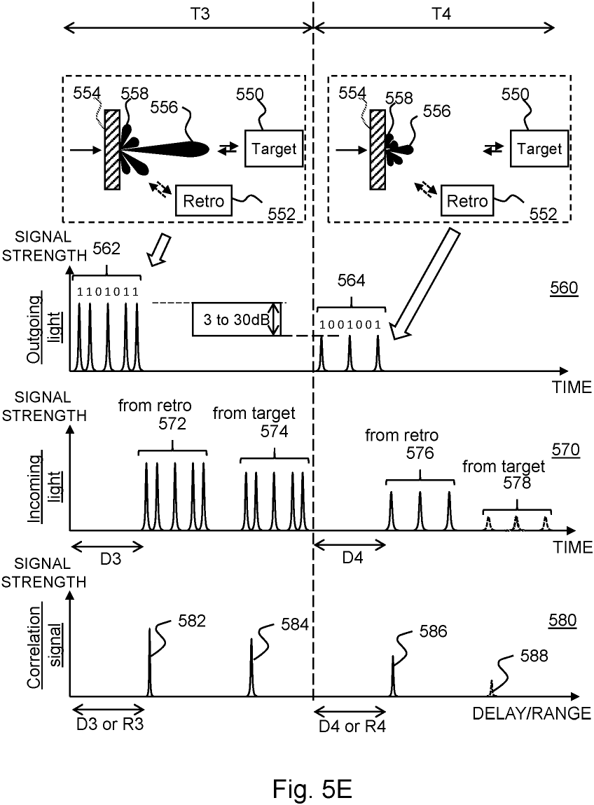

In FIG. 1, outgoing light for spatial estimation from the system 100 within its field of view is generally represented by arrow A and associated incoming light is generally represented by arrow B. In many applications, for example LIDAR, the outgoing light A is provided across a field of view of one or two dimensions and the spatial profile includes a variable depth dimension, transverse to the one or two dimensions. If the outgoing light hits a target, at least part of the outgoing light may be reflected, e.g. scattered, by the target back to the optics 103 and received at the light detector 104. The incoming light will include both the incoming light B to be detected for range determination and other noise light C, for example environmental light and interference, for example interference as described in the background section of the specification. The incoming light B may be detected as a signal within the incoming light received by the receiver based on one or more known characteristics of the outgoing light, for example its wavelength, phase and/or modulation. For example, in the use case of wavelength, the signal of FIG. 5A (see below) may be detected based on wavelength filtering the incoming light.

In some cases the incoming light C may have a relatively high intensity, approaching or exceeding that of incoming light B. For example, if outgoing light D is 30 dB lower than outgoing light A and is reflected by a retroreflector with 33 dB higher reflectivity than diffuse objects or other parts of the environment, then the return noise signal from the retroreflector may be higher than the return signal from the main mode of the laser reflected by a diffuse target. Accordingly, where the outgoing light includes a primary signal (e.g. light A) having a first optical characteristic and a secondary signal at less intensity (e.g. light D), preferably substantially less intensity, having a second optical characteristic distinguishable from the first optical characteristic, the secondary signal can function, based on its detected return, as a probe for detecting retroreflectors in the environment. The secondary signal may have an intensity at least 10 dB less than the primary signal, or at least 12 dB or 15 dB or 18 dB or 21 dB or 24 dB or 27 dB or 30 dB less than the primary signal.

Throughout this description, the term retroreflector is used to mean a target in an environment with a reflectivity higher than most or all diffuse targets detectable by the LiDAR system by an amount sufficient to create interference. For example a retroreflector may be a target with a reflectivity higher than most or all diffuse targets detectable by the LiDAR system by an amount equal to the SNR of the outgoing light or more.

In one arrangement, light from the light source 102 is also provided to the light receiver 104 for optical processing purposes via a direct light path 106 from the light source 102 to the light receiver 104. In other arrangements the direct light path 106 is omitted and predetermined information on the outgoing light, for instance information defining wavelength(s) and/or modulation is used for optical processing.

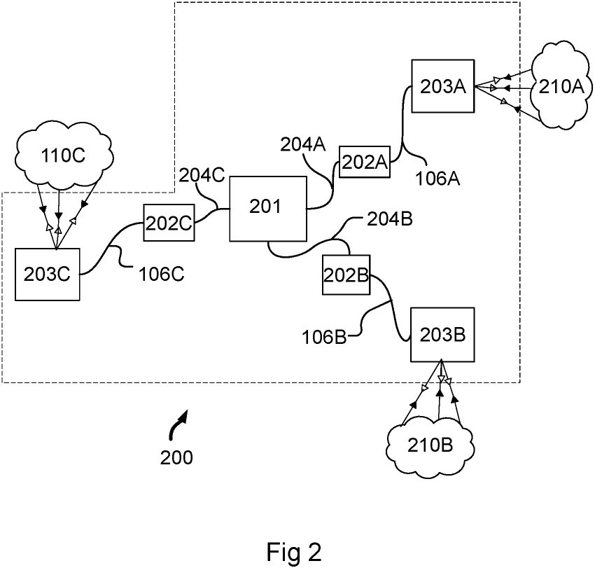

FIG. 2 shows block diagram representation of example embodiments of a spatial profiling system 200. The light source 102, the light receiver 104 and the processing unit 105 (see FIG. 1) are substantially collocated within a “central” unit 201. A spatial profiling system 200 may include one or more central units, in this example a single central unit 201, one or more amplifiers, in this example three optical amplifiers 202A-202C and one or more sets optical components, in this example three beam directors 203A, 203B and 203C. Each of the multiple optical amplifiers may be located close to the central unit 201 and optically coupled to the central unit 201 via respective optical fibres 204A, 204B and 204C. In alternative examples, non-optical amplifiers may be used instead of optical amplifiers. Each of the multiple beam directors may be optically coupled to the corresponding optical amplifier via respective optical fibres 205A, 205B and 206C. The beam directors may be placed at different locations and/or oriented with different fields of view of respective environments 210A to 210C.

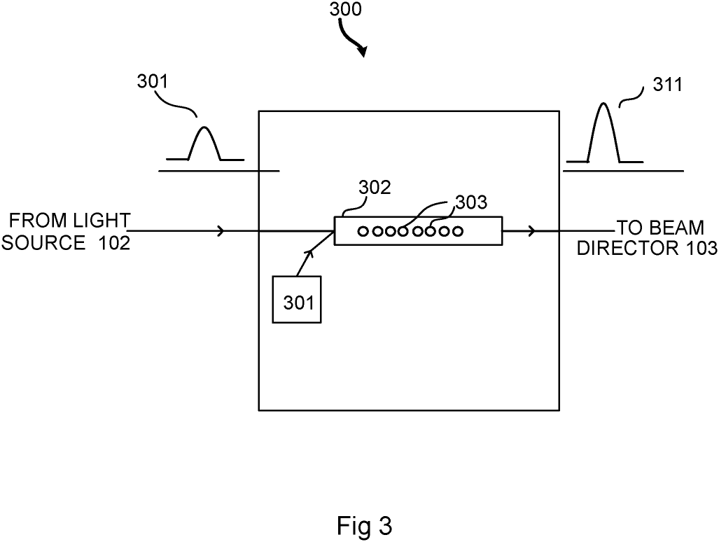

FIG. 3 shows a diagrammatic representation of an amplifier, in this example an optical amplifier 300. The optical amplifier 300 may, for example, be located in the optical path between the light source 102 and optics 103 of FIG. 1 or the optical amplifier 300 may be used as one or more of the amplifiers 202A-202C of FIG. 2. In one example, the optical fibre amplifier comprises a pump source 301 and an optical fibre 302 doped with rare earth dopants 303, e.g. Erbium or Ytterbium. The pump source 301 may pump rare earth dopants 303 in the fibre 302 to higher energy states. A light source input signal 310 to the amplifier 300 enters the optical fibre amplifier. The light source input signal 310 is from a light source, for example the light source 102 described herein above. In the example shown, the light source input signal 310 is representative of a pulse of light. The light source input signal 310 may be in other forms, for example a series of pulses or a continuous wave signal imparted with time-varying attributes such as amplitude or frequency modulation.

When the light source 102 is on, the light source input signal 310 interacts with the excited ions, i.e. the ions at the higher energy levels, to emit photons of substantially the same frequency to the light source output signal, resulting in an overall amplification of the light to produce light source output signal 311. The light source output signal 311 may then be provided to the optical components 103, for example to a beam director 203A-203C.

One example of the described optical fibre amplifier is an Erbium-doped fibre amplifier (EDFA). In other embodiments, the optical amplifier may be in another form that excites a gain medium to effect amplification, for example a semiconductor optical amplifier (SOA), a booster optical amplifier (BOA), or a solid state amplifier (e.g. a Nd:YAG amplifier). While only one stage of a doped fibre amplifier is illustrated in FIG. 3, a multi-stage amplifier may be incorporated in other embodiments. The stages may be of the same form (e.g. two or more EDFAs) or different forms (e.g. a SOA followed by an EDFA).

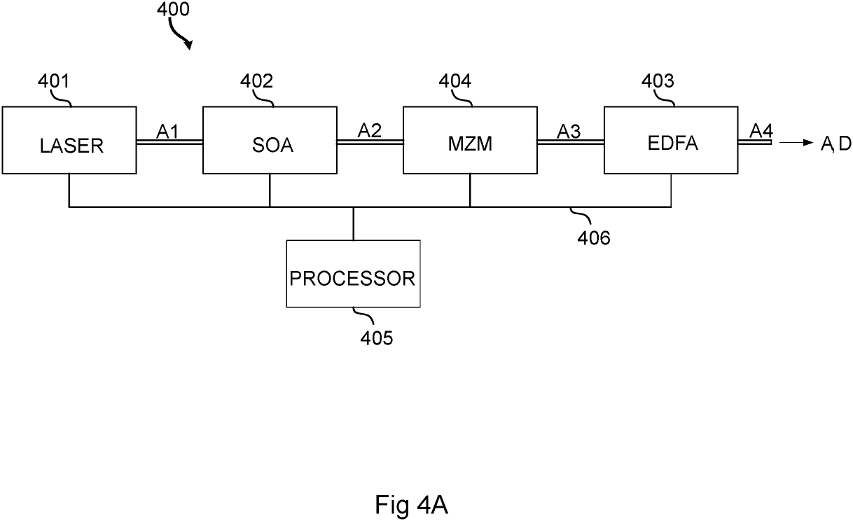

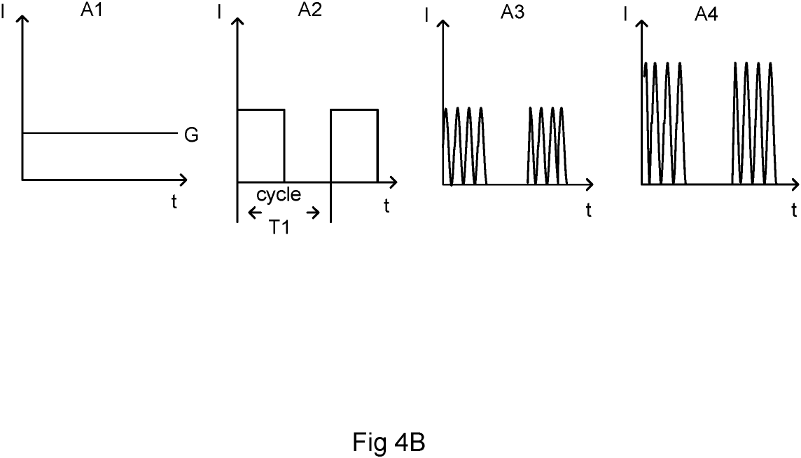

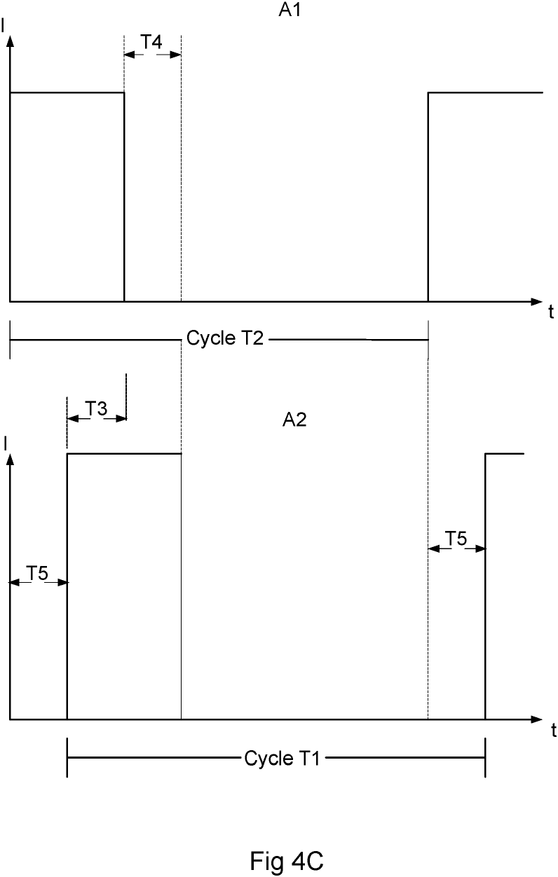

FIG. 4 illustrates an arrangement 400 of a light source, optical amplifier and processing unit for use in a spatial profiling system. The light source (LASER) 401 is a source of laser light, for example including a laser diode. The optical amplifier includes a first stage of a semiconductor optical amplifier (SOA) 402 and a second stage of an Erbium-doped fibre amplifier (EDFA) 403. The arrangement also includes a modulator (MZM) 404. The modulator 204, for example an amplitude modulator such as a Mach Zehnder modulator, in this example disposed between the amplifier stages, for imparting a time-varying intensity profile on the outgoing light A. The light path coupling may be via free-space optics, and/or optical waveguides such as optical fibres or optical circuits in the form of 2D or 3D waveguides. A processing unit (PROCESSOR) 405 controls operation of the arrangement, by providing control signals over control lines 406.

Referring to FIGS. 4A and 4B example light signals are now described. A representative signal A1 output from the laser 401 is plotted in FIG. 4B as an intensity profile over time. In some embodiments the intensity profile of signal A 1 is substantially constant, at least during a first mode of operation of the laser 401. The SOA 402 receives the light and amplifies it. The SOA 402 also switches the light so that the signal A2 from the SOA 402 has a duty cycle over the time period T1. The light is then modulated by the modulator 404 to produce signal A3. In one example, the modulator 404 applies amplitude modulation using a modulation code to produce coded bursts. The modulated light is amplified again to produce signal A4. Signal A4 may correspond to outgoing light A (see FIGS. 1 and 4A). For example, the amplified coded bursts 220 may be transmitted to the optical components 103 or a beam director 203A-203C. It will be appreciated that if the signal A3 has sufficient intensity, then there may be no need for second stage amplification and the amplifier 403 may be omitted.

The outgoing light also includes a noise component, represented in FIGS. 1 and 4A as outgoing light D. The spatial profiling system therefore has a signal to noise ratio (SNR) in the outgoing light. For example, the SNR may be about 30 dB. Taking the example of a spatial estimation system with a wavelength based beam director and an associated light source that selects different groups of one or more wavelengths to control beam direction, the outgoing light A will be the main mode or modes of the laser or lasers. The outgoing light D may be broadband noise, such as amplified spontaneous noise (ASE) in the case of optical amplifiers or electrically-induced noise in the case of non-optical amplifiers. Further, imperfections in optical systems may be magnified by the presence of a nearby retroreflector, and manifest as false return signals 802, associated with intended transmission directions surrounding the retroflector, as depicted in FIG. 8. For example, the light source may include spectral imperfections, such as spectral noise. Alternatively or additionally, the transmission optics may include spatial imperfections, such as spatial noise.

It will be appreciated that the components represented in FIG. 4A may be separate or form part of an integrated component. For example, a laser product may include both the laser 401 and the amplifier 402. Similarly, the modulator 404 and/or amplifier 403 may be separate from or also integrated into the laser product.

The signal A1 has a gain G1, represented in FIG. 4B with reference to the resulting intensity of light from the laser 401. In FIG. 4B the gain is substantially constant over the period shown during one mode of operation.

Referring now to FIG. 4C, depicting a second mode of operation, the gain G of the laser 401 is controlled, for example by the processing unit 405. In particular, the gain is controlled to be at one or more operational gain levels for generating outgoing light A for a period of time and controlled for another period of time to be at one or more non-operational gain levels, substantially reduced in comparison to the operational gain levels. For example the reduced gain may be zero, such as when the laser 401 is “off” or otherwise prevented from producing laser output. In another example the reduced gain may be at a level at least an additional 3 dB below the noise level (i.e. the level of outgoing light D in FIGS. 1 and 4A). For instance, if the SNR is 30 dB, the reduced gain may be at least 33 dB.

The laser 401 may, for example, be controlled to have a duty cycle during time period T2, switching between an operational gain level (e.g. the laser is “on”) and a non-operational gain level (e.g. the laser is “off”). The laser 401 and amplifier 402 are controlled to have time periods T3 in which the gain is at an operational level and the amplifier 402 is also operational (e.g. the amplifier is “on”). The arrangement 400 during time periods T3 is generating outgoing light A for spatial profiling and outgoing noise (outgoing light D). Outgoing light A includes the amplified and modulated laser light. Outgoing light D may be broadband noise.

The laser 401 and amplifier 402 are also controlled to have periods T4 in which the gain is zero or below operational level (e.g. the laser is “off”) and the amplifier 402 is operational (e.g. the amplifier is “on”). During time periods T4 even if the laser 401 does not emit any lasing output, the amplifier 402 continues to output noise, such as amplified spontaneous noise (ASE) in the case of optical amplifiers. Accordingly, outgoing light D (or a modified version of it taking account of differences caused by the absence of outgoing light A through the components) is present during time periods T4. The outgoing light D may result in a portion of incoming light C, due to being reflected back by the environment. If the outgoing light D is reflected by a retroreflector the incoming light C may approach or exceed incoming light B in intensity.

As described in more detail herein, detected returned light based on outgoing light D during period T4 (i.e. without outgoing light A) is utilised in the processing of detected returned light based on outgoing light A and outgoing light D during period T3.

The modulator 404 applies the same or different modulation during both periods T3 and T4. In some embodiments, the modulation of the outgoing light is inverted during period T4 in comparison to the modulation of the outgoing light during period T3. In other words every high bit during period T3 is replaced with a low bit in period T4 and every low bit during period T3 is replaced with a high bit in period T4. By way of a specific example, T3 may be a first period of 100 ns (or another selected time period within 10 to 1000 ns), during which optical power of the outgoing light is concentrated at the main laser mode (i.e. light A), for example about 190 THz (or another selected frequency within 1 THz to 1000 THz) and modulated as 1010100101100100, with the rest of the optical power distributed across the spectrum (i.e. light D). T4 may correspond to a second period of 100 ns (or another selected time period within 10 to 1000 ns), where most optical power of the outgoing light is spread out across the spectrum (i.e. modified light D) and modulated in an inverted manner as 0101011010011011), in the absence of the main laser mode (i.e. light A). There may be a transition period in the measurable light output, between the periods T3 and T4, for example spanning about 50 ns. In some embodiments, T3 and T4 may have the same or different durations, allowing the modulation during the periods T3 and T4 to correspond to different code lengths or numbers of bits. For example, T4 may be longer than T3, allowing the modulation during T4 to contain a longer code length or more bits than the modulation during T3. Having more bits and/or being longer in duration may increase return energy and hence probability of detection. Additionally or alternatively, the gain of the amplifier 402 may be the same or different during T3 and T4. For example, the gain of the amplifier 402 may be increased during T4 compared to that during T3. Increasing the gain may increase return energy and hence probability of detection. Since the instantaneous or peak power during T4 is weaker compared to that during T3, increasing the duration of T4 and/or increasing the amplifier gain during T4 may be advantageous in increasing probability of detection.

In some embodiments, the gain of the laser 401 is switched on before the amplifier 402 is switched on. This may allow, for example, a time period T5 for transient events following switching on of the laser 401 to fully or partially dissipate. The period T5 may be selected based on a known or measured transient time for the laser 401, for example to achieve an optimally small period T5 to conserve power, whilst still keeping transient effects in outgoing light A due to the switching of laser 401 to an acceptably low level, which level may be substantially no transient effects in outgoing light A. In other embodiments the gain of the laser 401 is switched on after the amplifier 402 is switched on or both the laser 401 and amplifier 402 are switched on at substantially the same time.

FIGS. 5A and 5B show graphs of signals based on incoming light in an example spatial profiling system operated in the second mode of operation, plotted with respect to time. The vertical axis in each case is in arbitrary units which are based on detected optical intensity at the associated time. The example spatial profiling system includes modulated outgoing light including a target seeking component and a retroreflector-seeking component. In this example, the target-seeking component of the outgoing light contains light A (main mode) and D (broadband noise) during T3 for range determination, and the retroreflector-seeking component of the outgoing light contains light D (broadband noise) without light A (main mode) during T4 for retroreflection detection. The graphs show signatures of a diffuse target and signatures of a retroreflector where the detected retroreflector is not a target. That is, the return from the retroreflector is based on at least the retroreflector-seeking component of the outgoing light.

For example, FIGS. 5A and 5B may result from operation of a LiDAR system with a beam director that operates to direct the outgoing light based on its wavelength. The LiDAR system may have a light source that includes a wavelength tunable laser. In another example, the laser source may include a broadband laser source and a tunable spectral filter to provide substantially continuous-wave (CW) light intensity at the selected wavelength. Detection of the diffuse target is based on the main mode of the light source (the tuned wavelength of the laser or pass band of the filter) during the target-seeking component and detection of the non-target retroreflector is based on broadband noise (such as ASE) at other wavelengths during the retroreflector-seeking component. The retroreflector is not a target because the noise has been directed into the environment by the beam director at a different direction to the direction of the main mode.

It will be appreciated that a similar arrangement to that described with reference to FIGS. 4A to 4C may be used in a flash LiDAR system, in which the outgoing light includes both the main mode(s) and noise for a period of time and then the noise without the main mode(s) for a period of time. Detected returned light when the main mode(s) are not transmitted may be used to identify retroreflectors. Further, while the noise can be characterised as being spectrally less dense than main mode(s), the respective noise spectra during the two periods are kept comparable, ideally equal, in spectral density. For example, by switching off the laser without switching off the optical amplifier, the respective noise power spectra can be maintained within 10 dB of each other at corresponding wavelengths.

The intensity of detected incoming light is shown in FIG. 5A. Based on the respective durations of the target-seeking component (e.g. T3) and the retroreflector-seeking component (e.g. T4) of the outgoing light, information of potential retroreflectors can be derived from the detected incoming light. For example, in the case of an outgoing light modulated in accordance with FIG. 4D, which includes the target-seeking component during a first (e.g. 100 ns as described above) period and the retroreflector-seeking component during a subsequent (e.g. 100 ns as described above) period, a diffuse target in the absence of a retroreflector would cause a return signal corresponding to the target-seeking component. In contrast, a diffuse target in the presence of a retroreflector would cause a return signal corresponding to the target-seeking component, which is either overlapped (fully or partially) or non-overlapped with an additional return signal corresponding to the retroreflector-seeking component. Any overlap would depend on the duration of the retroreflector-seeking component and the relative range between the target and the retroreflector. In the example of FIG. 5A, which is a non-overlapping example for clarity of illustration, the detected incoming light can be observed to include a diffuse target return signal commencing at about 340 ns, partially overlapped with a retroreflector return signal from about 160 ns to about 280 ns. The retroreflector return signal includes two parts, a first part corresponding to light D during time period T3 of FIG. 4C, and a second part corresponding to modified light D during time period T4 of FIG. 4C. In this example, following a specific example including an inverted modulation above, the first part of the retroreflector return signal is modulated in the same manner as the diffuse target return signal, whereas the second part of the retroreflector return signal is modulated in an inverted manner. Further, in this example, light D and modified light D are broadband noise that have comparable spectral density. The comparable noise spectra manifest in the two parts of the retroreflector return signal having approximately equal, hence easily resolvable, intensity, as shown in FIG. 5A (and similarly in FIG. 5C).

At least when a target return signal is non-overlapped with a retroreflector return signal, for instance when the target and retroreflector have relatively large range separation, the intensity of detected incoming light, such as that represented in FIG. 5A, may be sufficient to identify the presence of return signal interference due to one or more retroreflectors. For example, the presence of the two parts corresponding in time separation to time periods T3 and T4 is an indicator of interference by a retroreflector.

Additional or alternative processing may be used to identify retroreflector interference or increase the confidence in identification, for example in relation to instances when a target return signal is overlapped (fully or partially) with a retroreflection return signal. For example, in a system with a beam director that operates based on wavelength, a determination of a measure of a frequency of a signal in a detected signature may be used to indicate retroreflector interference. In another example, a processor correlates the detected incoming light with the outgoing light received during period T3. Correlation may be performed based on the modulation of the outgoing light. The modulation may for example be intensity, frequency, phase or code modulation.

FIG. 5B shows a cross correlation of modulation characteristics of the outgoing light during period T3 (see FIG. 4C) with the detected incoming light represented by FIG. 5A in an embodiment in which the modulation of the outgoing light is reversed during period T4 in comparison to the modulation of the outgoing light during period T3. In the example, correlation is performed based on the modulation of the outgoing light. The modulation may for example be intensity, frequency, phase or code modulation. In some embodiments, a specific modulation is periodically used for the purpose of detecting retroreflector interference, for example one every nth transmission of outgoing light, where n is an integer. An example of a specific modulation is one that results in a single “big” pulse, for example “111111”, which can be readily detected in the raw signal and/or by the output of a cross-correlation algorithm. Using a specific modulation for retroreflector interference detection may facilitate use of other modulations for other purposes. Both FIGS. 5A and 5B are over a time period showing a single range measurement. Referring to FIG. 4C the plots may, for example, show operation over a cycle T2.

The cross correlation of FIG. 5B shows three peaks, referenced 1, 2 and 3. These can be used to assist in the identification of retroreflector interference signatures and target signatures. For example, the presence of a pair of “positive” and “negative” correlations in peaks 1 and 2 is indicative of retroreflector interference. The absence of a pair to peak 3 indicates that it is likely a diffuse target in the field of view.

Further, the relative correlation of Peaks 1 and 2 can indicate a measure of likelihood that there is a diffuse target within the field of view at the same distance from the LiDAR as the retroreflector is that is causing the interference signal. For example, the relative magnitude of the correlations for each part of the retroreflector return signal in the absence of such a diffuse target can be a determined variable for the LiDAR system, for example by testing or experimentation. If there is a difference in this relative magnitude, for example a difference beyond a threshold amount, then this difference may indicate both a diffuse target within the field of view and a retroreflector causing an interference signal at about the same distance from the LiDAR system. The threshold amount may vary with the magnitude of the correlation, for example decreasing with higher signal to noise ratios an increasing with lower signal to noise ratios and/or due to being a proportion of the magnitude rather than a fixed amount variation. Different actions may be taken by the LiDAR system based on whether the correlation exceeds the threshold or not. For example, the LiDAR system may identify the detected return signal associated with Peak 1 as interference if the threshold is exceeded (i.e. there is a higher correlation) and identify the detected return signal associated with Peak 1 as a target or potential target if the threshold is not exceeded (i.e. there is a lower correlation).

FIG. 5C shows an example of the intensity of detected incoming light in which no diffuse target is detected in the field of view and retroreflector interference is present. As described above, the identification of the signature as retroreflector may be determined by the respective durations of the target-seeking component (e.g. T3) and the retroreflector-seeking component (e.g. T4) of the outgoing light or based on these together with other variables, including for example the output from a correlation process.

FIG. 5D shows an example of the intensity of detected incoming light in which a diffuse target is detected in the field of view and retroreflector interference is not present. The absence of a signature with two components may be indicative that the detected signature is a diffuse target. Accordingly, the LiDAR system may determine that no further processing for “retroreflector-seeking” is required.

FIG. 5E show graphs of signals in another example of spatial profiling system operated in the second mode of operation, plotted with respect to time or delay/range. The vertical axis in each case is in arbitrary units which are based on detected optical intensity or correlation magnitude at the associated time. The example spatial profiling system includes modulated outgoing light 560 including a target seeking component 562 associated with T3 and a retroreflector-seeking component 564 associated with T4.

In this example, the target-seeking component 562 contains light A (e.g. light at an intended direction 556) and D (e.g. light at unintended direction(s) 558) for range determination, and the retroreflector-seeking component 564 contains the same proportional amounts of light A and D at reduced intensity, for retroreflection detection. The reduction in intensity may be anywhere between 3 dB and 30 dB, such as 3 dB, 6 dB, 10 dB, 13 dB, 16 dB, 20 dB, 23 dB, 26 dB or 30 dB. The graphs show signatures of a diffuse target 550 and signatures of a retroreflector 552 where the detected retroreflector is not a target. That is, the return from the retroreflector 552 is based on at least the retroreflector-seeking component 564 of the outgoing light 560. The target seeking component 562 and a retroreflector-seeking component 564 may have the same modulation (not shown) or different modulation (as shown in FIG. 5E). For example, as shown in FIG. 5E, the target seeking component 562 is code-modulated with a code sequence 1101011 and the retroreflector-seeking component 564 is code-modulated with a code sequence 1001001.

FIG. 5E may result from operation of a LiDAR system with a beam director that operates to direct the outgoing light 560 based on transmission optics 554 including a periodic structure, such as a diffraction grating or an optical phased array. Detection of the diffuse target 550 is based on the main lobe transmission 556 of the transmission optics 554 (i.e. light transmitted at an intended direction). Detection of the non-target retroreflector 552 is based on side lobe transmission 558 of the transmission optics 554 (i.e. light transmitted at unintended direction(s)). The main lobe transmission 556 is desired signal, whereas the side lobe transmission 558 is undesired noise which typically has lower intensity than the main lobe transmission 556, with their ratio being the signal-to-noise ratio. The retroreflector 552 is not a target because the side lobe emission 558 has been directed into the environment by the beam director at a different direction to the direction of the main lobe emission 556.

Responsive to the target-seeking component 562 of the outgoing light 560, the incoming light 570 contains both a retroreflector signature 572 and a target signature 574. Responsive to the retroreflector-seeking component 564 of the outgoing light 560, the incoming light 570 contains a retroreflector signature 576, and may or may not contain a target signature 578. For illustrative purposes, the magnitude of target signature 578 responsive to the retroreflector-seeking component 564 is exaggerated and depicted in dotted lines. In practice, because diffuse targets tend to have a much more rapidly decreasing reflectance over distance than retroreflectors, any target signature 578 responsive to the retroreflector-seeking component 564 tends to be below the noise floor of the detection. The lack of detected target signature 578 responsive to the retroreflector-seeking component 564 therefore indicates the presence of a nearby retroreflector in the environment. In some embodiments, the processing unit 105 may determine a cross-correlation over delay between the detected incoming light 560 and the detected outgoing light 570. The delay at which the cross-correlation peaks can be used as determination for range. Following the example above, the correlation signal 580 contains a retroreflector signature 582 and a target signature 584 responsive to the target-seeking component 562, as well as a retroreflector signature 586 and a target signature 588 responsive to the retroreflector-seeking component 564.

Based on detected retroreflector signatures (or lack thereof) and detected target signatures (or lack thereof) associated with T3 and T4, the processing unit 105 may take one or more actions. In one scenario, based on detected presence of both retroreflector and target signatures associated with T3 and detected presence of a retroreflector signature associated with T4, the processing unit 105 may be configured to determine presence of both a retroreflector and a diffuse target in the environment. Additionally or alternatively, the processing unit 105 may be configured to reject or disregard signatures 572/582 and 576/586, such as attributing them to or associated them with a nearby retroreflector, based on their matched delays (e.g. D3 and D4) or matched ranges (e.g. R3 and R4). Matched values may be based on matching within a threshold, and do not necessarily indicate identical delays and ranges. Still additionally or alternatively, the processing unit 105 may be configured to associate signature 574/584 with a target, based on the rejected or disregarded signatures 572/582 and 576/586.

In another scenario (not shown), where a nearby retroreflector is present in and a target is absent from the environment, target signatures 574/584 and 578/588 are absent and retroreflector signatures 572/582 and 576/586 are present. Based on the detected presence of a retroreflector signature associated with T3 and detected presence of a retroreflector signature associated with T4 without any detected presence of a target signature associated with either T3 or T4, the processing unit 105 may be configured to determine presence of a retroreflector without a diffuse target in the environment. Additionally or alternatively, the processing unit 105 may be configured to reject or disregard signatures 572/582 and 576/586, such as attributing them to or associated them with a nearby retroreflector.

In yet another scenario (not shown), where a nearby retroreflector is absent from and a target is present in the environment, retroreflector signatures 574/584 and 578/588 are absent and target signature 574/784 is present. Based on the detected presence of a target signature associated with T3, without any detected presence of a retroreflector signature associated with either T3 or T4, the processing unit 105 may be configured to determine presence of a target without a nearby retroreflector in the environment.

In the arrangements of FIGS. 4 and 5, the primary signal for seeking general targets (which may include diffuse targets and retroreflector targets) corresponds to light having a first optical characteristic (e.g. narrowband light modulated based on a first code), whereas the secondary signal for probing retroreflectors corresponds to light having a second optical characteristic at substantially reduced intensity or reduced spectral density, such as reduced temporal peaks or reduced spectral peaks (e.g. broadband noise modulated based on a second code). The two optical characteristics are distinguishable, based on the difference between the first code and the second code. The primary signal and the secondary signal are combined for light transmission into the environment (i.e. code-multiplexed) and distinguished following their return (i.e. code-demultiplexed). A skilled person would appreciate that the primary and secondary signals may assume alternative forms other than involving noise, and without necessarily carrying distinguishable codes or occupying different time periods, to effect alternative multiplexing arrangements.

One such alternative arrangement is wavelength multiplexing, where the primary signal is provided as light at a designated wavelength channel, and the secondary signal is provided as light at another designated wavelength channel at substantially reduced intensity compared to that of the primary signal (e.g. a weak pilot). Here, the first optical characteristic is distinguishable from the second optical characteristic based on wavelength. The two signals may be combined for transmission into the environment via a wavelength multiplexer and distinguished upon return via a tunable spectral filter. For example, where the primary signal is pulsed light centered at 1550.0 nm with 0 dBm total signal power, the secondary signal may be pulsed light centered at 1551.0 nm with total signal power less than -10 dBm, -15 dBm, -20 dBm, -25 dBm or -30 dBm. This alternative arrangement, where the secondary signal is spectrally narrow, may be suited to LiDAR systems that rely on few or a narrow range of wavelengths. In comparison, the arrangements of FIGS. 4 and 5, where the secondary signal is spectrally broad, may be suited to LiDAR systems relying on multiple or a broad range of wavelengths.

Other alternative multiplexing arrangements that combine the primary signal and the secondary signal and distinguish between them upon return include polarisation-mode-multiplexing, orbital-angular-mode-multiplexing and subcarrier-multiplexing. In polarisation-mode-multiplexing, the primary signal may be provided as light at a first polarisation state (first optical characteristic), and the secondary signal may be provided as light at a second polarisation state orthogonal to the first polarisation state (second optical characteristic) and at substantially reduced intensity compared to that of the primary signal. In orbital-angular-mode-multiplexing, the primary signal may be provided as light at a first orbital angular mode (first optical characteristic), and the secondary signal may be provided as light at a second orbital angular mode orthogonal to the first orbital angular mode (second optical characteristic) and at substantially reduced intensity compared to that of the primary signal. In subcarrier-multiplexing, the primary signal and secondary signal may be provided as, respectively, light at a first subcarrier frequency (first optical characteristic) and a second subcarrier frequency different to the first subcarrier frequency (second optical characteristic) and at substantially reduced amplitude compared to that of the first subcarrier.

In some embodiments, any two or more of the above multiplexing arrangements may be combined, for example to increase the distinguishability.

In some embodiments, the processing unit 405 is configured to identify presence of either or both of a diffuse target and a retroreflector target based on signatures contained in the detected incoming light. For example, the processing unit may be configured to determine the identification based on any matching characteristics with either or both of the primary signal and secondary signal:

| | | |
|---|---|---|
| Signatures in incoming light | Presence of diffuse target? | Presence of retroflector target? |
| Signatures matching primary signal characteristics | Yes | No |
| Matching secondary signal characteristics | No | Yes |
| Matching both primary and secondary signal characteristics | Yes | Yes |

In the arrangements of FIGS. 4 and 5, the matching signatures include matching code modulation. Using FIGS. 5A, 5C and 5D as examples, signatures matching the primary signal (which is modulated as 1010100101100100 during T3) are present in both FIGS. 5A and 5D in both the first part of the retroreflector return signal and the diffuse target return signal. Signatures matching the secondary signal (which is modulated as 0101011010011011 during T4) are present in both FIGS. 5A and 5C in the second part of the retroreflector return signal. In other examples, depending on the multiplexing arrangements, the matching signatures include matching wavelength channels, matching polarisation states, matching orbital angular modes, or matching subcarrier frequencies.

The return signal (e.g. FIG. 5A) and/or a cross-correlation of the return signal (e.g. FIG. 5B) can also be used to derive information on the retroreflector(s) and/or information on the diffuse target. For example a processor for the LiDAR system can determine a distance to the retroreflector(s) and/or a respective distance of one or more targets and one or more retroreflectors. From the example signals of FIGS. 5A and 5B it is readily determinable that the retroreflector is closer to the system than the diffuse target. A computation of a measure of the distance to the retroreflector may be based on the location in time of the first peak of a detected retroreflector (e.g. Peak 1 in FIG. 5B or the corresponding signature part in FIG. 5A) in the same way as the distance to target objects (e.g. Peak 3 in FIG. 5B or the corresponding signature part in FIG. 5A). A measure of distance to the retroreflector may be based on the location time of the second peak of a detected retroreflector, with the computation recognising the later transmission that causes the return signal. A measure of the distance to the retroreflector could be based on both peaks, for example by averaging a distance computation based on each of them.

In embodiments in which the transmission direction or directions of the secondary signal or a component of the secondary signal is confined to one or more directions or ranges of directions and known or determinable, then a direction of the retroreflector(s) may also be determined, in the same way as for the primary signal. For example, a relatively broadband secondary signal may include a particular modulation for one or more wavelength channels, formed by wavelength filtering the secondary signal.

One or more actions of the LiDAR system may be based on the processing of the detected and/or correlated incoming light. The action or actions will depend on the type of LiDAR system and its configuration. In general, the response of the LiDAR system to retroreflectors may be determined, for example experimentally and/or deductively and one or more effects on the operation of the LiDAR system identified. The action or actions will also depend on the extent to which the LiDAR system processes the incoming light to perform spatial estimation - e.g. whether formation of the spatial estimation is a function of the LiDAR system or a function of another processing system in communication with the LiDAR system (which provides relatively unprocessed data suitable for spatial estimation).

The actions may include for example providing an output indicating or flagging one or more of: the existence of retroreflector interference in the detected and/or correlated incoming light, a point in time in the detected and/or correlated incoming light at which a retroreflector was detected, and a measure of the magnitude of the detected incoming and/or correlated light associated with the detected retroreflector. Based on the point in time in the detected and/or correlated incoming light at which a retroreflector was detected, the actions may include providing an additional output indicating the range of the retroreflector.

The actions may include adapting operation of the LiDAR system based on the output. For example a subsequent transmission of outgoing light may be at a different power, for example a reduced power at the main mode or modes directed to the same coordinates. The detected return light, if any, based on the subsequent transmission may provide more information of use in forming the estimate of the spatial profile of the environment. The additional information may be of use for addressing potential interference by the retroreflector and/or for addressing potential saturation of the detector due to the high power returned, which may affect the accuracy of distance estimation for a retroreflector. For example detected return light based on a noise only transmission of outgoing light may be used for distance determination of a retroreflector, in addition to or instead of the detected return light from the retroreflector based on the main mode(s) of the laser.

The actions may include treating one or more detected targets differently or providing an output indicating that one or more detected targets may be associated with a retroreflector. Examples of these actions may include rejecting a peak in the correlated incoming light in response to a detected retroreflector, and/or identifying a peak in the correlated incoming light as corresponding to a target. Rejection of a peak in response to a detected retroreflector reduces the occurrence of interference falsely representing a target (i.e. a false positive).

While the timing arrangement described with reference to FIG. 4C indicates a period of transmission of the main modes of the laser (i.e. period T3) immediately followed by a period of transmission without or substantially without the main modes (i.e. period T4), other timing arrangements may be used. For example, period T4 may instead precede period T3 and/or periods T3 and T4 may be separated in time, for example by a period of time in which there is no transmission.

Additionally, while the arrangement described with reference to FIGS. 4A to 4C utilise the gain of the laser 401 and gain of the amplifier 402 to create transmissions with the characteristics of periods T3 and T4, other control variables may be used. For example, the laser 401 may transmit continuously and the amplifier 402 used to provide output corresponding to output A1 in FIG. 4C. The output corresponding to output A2 in FIG. 4C may then be generated by the amplifier 403. In another example, the amplifier 402 may be continuously at operational levels and the modulator 404 may create an output corresponding to output A1.

Additionally, while the example signals in FIGS. 5A and 5B are in relation to a single laser output, the LiDAR system may have more than one laser output. For example, the LiDAR system may have a bank of lasers and/or have a plurality of beam directors, for instance as described with reference to FIG. 2. The central unit 201 may be controlled to output light having a form similar to signal A1 of FIG. 4C. The signal A1 may be common to each of the optical fibres 204A to 204C or may be different, including for example by being offset in time from one another and/or having a different duty cycle and/or having different signal characteristics, such as wavelength, amplitude or modulation. Two or more of the optical amplifiers 202A to 202C may be controlled in a like manner to the amplifier 402. Accordingly, two or more transmission path instances of outgoing light through the beam directors 203A to 203C have a transmission period T3 and a transmission period T4. Knowledge of the timing of these transmission periods can be used to provide information for processing one or both of detected return light for the same transmission path and another of the transmission paths.

For example, if light output from the beam director 203A overlaps with the field of view of the beam director 203B, then noise from the central unit 201 and amplifier 202A output by the beam director 203A may be reflected off a retroreflector and received by the beam director 203B, creating interference. By having the beam director 203A transmit only or substantially only its noise component for a period of time and detecting return light from the retroreflector received by the beam director 203B, additional information is available for determining the spatial profile of the environment based on the detected signals received by the bean directors 203A and 203B.

One or more of the laser outputs may provide both a primary and a secondary signal. In some embodiments all of the laser outputs may provide both a primary and a secondary signal. An example of a laser output providing both a primary and a secondary signal is where the secondary signal is a noise component for a laser output. Another example is where the secondary signal has a confined wavelength and one laser output provides a secondary signal within a first wavelength range and another laser output provides a secondary signal within a second wavelength range, different to the first wavelength range.

One or more of the laser outputs may provide only a primary signal. For instance one or more light sources may be utilised with optical components that do not include imparting modulation or another detectable characteristic for retroreflector probing to any generated secondary signal.

One or more of the laser outputs may provide only a secondary signal. For instance one or more light sources may be utilised with optical components to provide only a relatively low power (in comparison to the primary signal) light output, for retroreflector probing. These light sources may be not used for a primary signal and in some embodiments may be unsuitable for a primary signal, for instance due to utilising a low power light source.

In some embodiments one or more laser outputs provide only the primary signal and one or more other laser outputs provide both a primary signal and a secondary signal.

The primary signal and the secondary signal may be transmitted by a light source at different non-overlapping time intervals. Transmission may be alternated between the primary signal and the secondary signal. In some embodiments the secondary signal is transmitted whenever the primary signal is not transmitted. In other embodiments there are periods in which neither the primary signal nor the secondary signal are transmitted. Alternatively the primary and the secondary signal may be transmitted by a light source at the same or at overlapping time intervals.

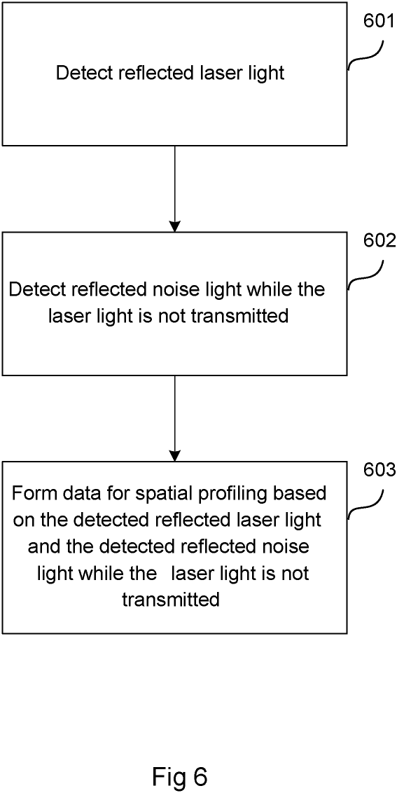

FIG. 6 shows an example method for a spatial profiling system. The method may, for example, be performed by the processing unit 105. The processing unit 105 may be a general purpose computer processing system or an application specific processing system. The processing unit 105 may be a single computer processing device (e.g. a central processing unit, graphics processing unit, application specific integrated circuit or other computational device), or may include a plurality of computer processing devices. In some embodiments, the or each processing device is in data communication with a one or more machine readable storage (memory) devices which may be non-transient or a combination of non-transient and transient memory and which store instructions and/or data for controlling operation of the processing unit 105. The processing unit includes one or more interfaces, for communication with devices of the spatial profiling system or outside the spatial profiling system and/or communication with networks. The method of FIG. 6 relates to functions performed by a processing unit in relation to light detected by a light receiver, for example the light receiver 104.

In step 601, the processing unit detects first incoming light from an environment, the first incoming light including reflected laser light from the spatial profiling system. Step 601 may be performed following or responsive to the processing unit controlling a light source (e.g. light source 102) to, over a first period of time, send outgoing light into the environment that includes signal and noise. The reflected laser light in the first incoming light includes information from which a spatial estimation may be formed, either by the processing unit itself or by another processing unit, which may be remote to the processing unit.

In step 602, the processing unit detects second incoming light from the environment, the second incoming light including reflected noise light from the spatial profiling system while the laser light is not transmitted. Step 601 may be performed following or responsive to the processing unit controlling a light source (e.g. light source 102) to, over a second period of time, send outgoing light into the environment that includes noise but does not include or substantially does not include signal. The noise light from the spatial profiling system is imparted with a signature, for example by being modulated, for identification from other environmental noise.

The order of steps 601 and 602 may be reversed. In the case of reversal, the second incoming light is detected earlier in time and the first incoming light is detected later in time. The time periods for steps 601 and 602 may be contiguous, substantially contiguous or separated in time. Alternatively, the time periods for steps 601 and 602 may overlap in whole or in part.

In step 603, the processing unit modifies data for a spatial profile estimation based on the detected first incoming light, wherein the modifying is based on the detected second incoming light. The modification may include an addition or deletion from data defining the information from which a spatial estimation may be formed. Example actions are described elsewhere herein.

In combination with information about retroreflectors in the environment, the foregoing techniques may be applied to reduce occurrence of false negatives due to nearby retroreflectors. More specifically, where a target return signal (e.g. Peak 3 in FIG. 5B) significantly overlaps with interference (e.g. Peak 1 in FIG. 5B), the interference may mask or dominate over the target return signal, causing the processing unit 105 to incorrectly reject the entire signal as interference (i.e. a false negative). Such false negatives may occur when a diffuse target is at substantially the same distance as a nearby retroreflector.

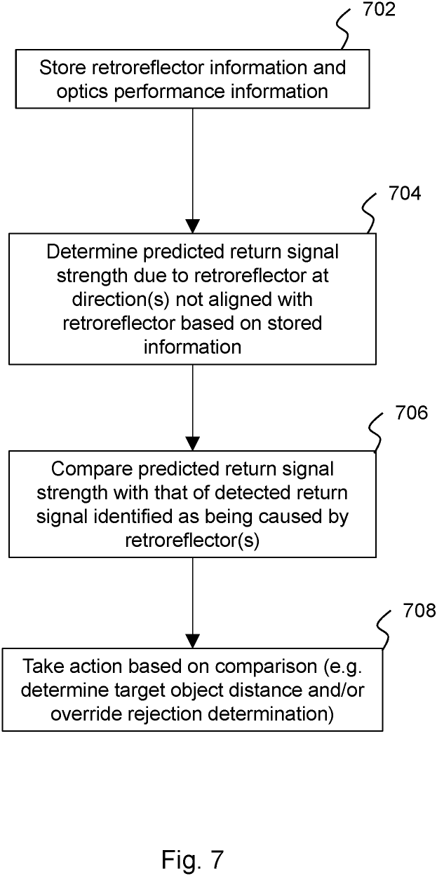

In embodiments, in reference to FIG. 7, the processing unit 105 is at step 702 configured to store retroreflector information, such as any one or more of transmission direction, distance and reflectivity of any detected retroreflector(s) in the field of view. The retroreflector information may be obtained a priori, for example during a previous scan or from previous pixels of the current scan. The processing unit 105 may determine a return signal as associated with a retroreflector based on a measured value of reflectivity above a certain threshold and/or based on saturation of the detector. At step 702, the processing unit 105 is also configured to store performance information associated with the optical components, such as the spectral performance data of the light source and/or spatial performance data of the transmission optics. The performance information may be measured or characterised at the time of manufacturing, and stored in memory retrievable by the processing unit 105.

At step 704, the processing unit 105 is configured to determine a predicted return signal strength, such as a predicted magnitude of correlation. The predicted return signal strength may be determined based on the stored information, for example expected return signals due to retroreflector(s) along one or more transmission directions not aligned with the retroreflector(s). The processing unit 105 may first retrieve transmission direction(s) associated with the retroreflector(s) based on the retroreflector information. The processing unit 105 may then retrieve the performance information associated with the retrieved transmission direction(s). Based on the retroreflector information and the performance information, the processing unit 105 determines the predicted return signal strength due to the retroreflector(s) along one or more transmission directions not aligned with the retroreflector(s).

At step 706, the processing unit 105 is configured to compare the predicted return signal strength with the strength of a detected return signal determined to be associated with a retroreflector according to the foregoing techniques. For example, the processing unit 105 may determine whether the detected return signal strength is higher than the predicted return signal strength, such as higher by a threshold amount.

At step 708, the processing unit 105 is configured to take an action based on the comparison. For example, based on the higher-than-predicted return signal strength, the processing unit 105 may determine that the detected return signal is associated with a diffuse target, as well as a retroreflector. Alternatively or additionally, the processing unit 105 may determine the existence and/or distance of the diffuse target, and/or may override any determination to reject the detected return signal as being interference. This way, occurrence of false negatives due to the masking of a genuine return by interference may be reduced.

Throughout this specification and in the accompanying claims, unless the context clearly requires otherwise, the terms “first” and “second” are used to indicate separate instances of the article referred to. The terms are not intended to indicate and do not indicate a specific order, timing arrangement or otherwise.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A method for use in a spatial profiling system for detecting targets in an environment, the method including:
by optical and electrical components of a spatial profiling system:
sending first outgoing light into the environment, the first outgoing light including a signal with first characteristics for detection of diffuse targets in the environment;
sending second outgoing light into the environment, the second outgoing light including a signal with second characteristics different to the first characteristics and an intensity or spectral power density less than the first outgoing light;
detecting incoming light including first incoming light and second incoming light, wherein the first incoming light is a portion of the first outgoing light reflected by a target in the environment and the second incoming light is a portion of the second outgoing light reflected by a target in the environment;
generating, by the spatial profiling system, data including information identifying detection of the first incoming light and information identifying detection of the second incoming light; and
causing an action by the spatial profiling system based on the information identifying detection of the second incoming light.

2. The method of claim 1, further including determining, by the spatial profiling system based on the detected first incoming light and second incoming light, presence of both a diffuse target and a retroreflector target in the environment.

3. The method of claim 2, further including determining, by the spatial profiling system based on the detected first incoming light and second incoming light, presence and location of a diffuse target and presence of a retroreflector target in the environment.

4. The method of claim 2, further including determining, by the spatial profiling system based on the detected first incoming light and second incoming light, presence and location of a diffuse target and presence and location of a retroreflector target in the environment.

5. The method of claim 1, wherein the first outgoing light includes signal and noise and the second outgoing light includes noise and no or substantially no signal.

6. The method of claim 5, including sending the first outgoing light in a first period of time and sending the second outgoing light in a second period of time, different to the first period of time.

7. The method of claim 6, further including:
determining that there is a match between:
a time separation between a detected return signal in the detected first incoming light and a detected return signal in the detected second incoming light; and
a time separation between the first period of time and the second period of time;
wherein the causing of the action by the spatial profiling system is responsive to the determination of a match.

8. The method of claim 6, wherein the signal includes light from a laser light source with wavelengths within a wavelength range and the noise includes light outside of the wavelength range.

9. The method of claim 8, including controlling the laser light source so that the second outgoing light includes no signal.

10. The method of claim 9, wherein the laser light source includes a laser and the method incudes controlling a gain of the laser to zero for sending the second outgoing light into the environment.

11. The method of claim, including setting a gain of the laser to an operational value for the first time period before commencement of the first time period and controlling an amplifier for the laser light source to an operational state from a non-operational state to commence the first time period.

12. The method of claim 11, wherein the second time period follows the first time period and the method includes transitioning from a configuration for the first time period to a configuration for the second time period by setting the gain of the laser to a non-operational value to end the first time period while maintaining the amplifier in the operational state.

13. The method of claim 11, further comprising transitioning from a configuration for the second time period by transitioning the amplifier from the operational state to the non-operational state.

14. The method of claim 1, wherein the optical and electrical components include a laser light source with an associated amplifier, controlled by one or more processing units and wherein the method includes:
configuring, by the one or more processing units, the laser light source and the amplifier into a first configuration in which both are operated to generate the signal;
configuring, by the one or more processing units, the laser light source and the amplifier into a second configuration in which the laser light source ceases generating signal and the amplifier remains in the same operating state as the first configuration; and
applying, by the one or more processing units, the first configuration during one of the first time period and the second period and the second configuration during the other time period of the first time period and the second time period.

15. (canceled)

16. (canceled)

17. The method of claim 1, wherein the first outgoing light has a first modulation and the method further includes:
determining a match between a modulation in the detected second incoming light and a second modulation, different to the first modulation, of the second outgoing light;
wherein the causing of the action by the spatial profiling system is responsive to the determination of a match.

18. (canceled)

19. A method for use in a spatial profiling system for detecting targets in an environment, the method including:
by a light receiver of a spatial profiling system:
detecting first incoming light from an environment, the first incoming light including reflected laser light from the spatial profiling system;
detecting second incoming light from the environment, the second incoming light including reflected noise light from the spatial profiling system while the laser light is not transmitted;
by a processing system of the spatial profiling system:
modifying data for a spatial profile estimation based on the detected first incoming light, wherein the modifying is based on the detected second incoming light.

20. The method of claim 19, further including:
determining that a time separation between a first detected return signal in the first detected incoming light and a second detected return signal in the second detected incoming light is within a threshold range;
wherein the modification of the data for the spatial profile estimation is responsive to the determination.

21. (canceled)

22. (canceled)

23. A spatial profiling system including
optical components for directing outgoing light into an environment and receiving light from the environment including outgoing light reflected by the environment, the outgoing light including laser light for spatial profiling, the optical components directing light based its wavelength;
one or more noise generating components that operate to add noise to the directed outgoing light;
a light receiver and processing unit configured generate data for a spatial estimation of the environment based on the light received from the environment;
wherein the light receiver and processing unit is configured to:
detect first incoming light from an environment, the first incoming light including reflected laser light from the spatial profiling system;
detect second incoming light from the environment, the second incoming light including reflected noise light from the spatial profiling system while the laser light is not transmitted;
modify data for a spatial profile estimation of the environment based on the detected first incoming light, wherein the modifying is based on the detected second incoming light.

24. The spatial profiling system of claim 23, wherein the one or more noise generating components includes an amplifier.

25. (canceled)

26. (canceled)

27. The spatial profiling system of claims 23 including a modulator configured to modulate the outgoing light and the noise, wherein the light receiver and processing unit is configured to detect the reflected laser light and reflected noise light based on the modulation imparted to the outgoing light by the modulator.

28. (canceled)
